(19) United States
(12) Patent Application Publication
(10) Pub. No.: US 2025/0118226 A1
(43) Pub. Date: Apr. 10, 2025

(54) WASH-OFF LABEL

(71) Applicant: UPM Raflatac Oy, TAMPERE (FI)

(72) Inventors: Sari PIRKKANEN, Helsinki (FI); Bartosz JANICKI, Helsinki (FI)

(21) Appl. No.: 18/832,207

(22) PCT Filed: Jan. 23, 2023
(86) PCT No.: PCT/FI2023/050046

§ 371 Date: Jul. 23, 2024

(30) Foreign Application Priority Data
Jan. 28, 2022 (FI) 20225077

(51) Int. Cl. G09F 3/02; C09J 7/38

(52) U.S. Cl. CPC G09F 3/02; C09J 7/385; C09J 2203/334; G09F 2003/0216; G09F 2003/0244

(57) ABSTRACT

The specification relates to a wash-off label (100, 200) comprising a face (101, 301) and a pressure sensitive adhesive (102, 302) adjoined to the face, wherein the face (101, 301) comprises corona discharged filmic material and the pressure sensitive adhesive (102, 302) has a composition including at least one acrylic polymer comprising acrylic monomer(s) and/or non-acrylic comonomer(s) having a carbonyl group capable of undergoing a crosslinking reaction, amount of the acrylic monomer(s) and/or non-acrylic comonomer(s) having a carbonyl group capable of undergoing a crosslinking reaction being from 0.1 to 5 wt. % of monomer composition, and a crosslinking agent with dihydrazide functionality, amount of the crosslinking agent being from 20 to 150% with respect to the amount of the carbonyl groups capable of undergoing a crosslinking reaction. The wash-off label (100, 200) is detachable from a surface when exposed to an alkaline washing solution at a temperature of 85 degrees C. the detachability being such that the pressure sensitive adhesive (102, 302) remains attached to the face (101, 301). Further, the specification relates to a labelled item and use of the wash-off label for labelling an item. Still further, the specification relates to a label laminate web and a method of manufacturing the wash-off label as well as to a pressure sensitive adhesive composition for a wash-off label.

### TECHNICAL FIELD

This specification relates to a wash-off label. Further, the specification relates to a labelled item and use of the wash-off label for labelling an item. Still further, the specification relates to a label laminate web and a method of manufacturing the wash-off label as well as to a pressure sensitive adhesive composition for a wash-off label.

### BACKGROUND

It is general practice to apply a label to the surface of containers, such as bottles made of polymer or glass, to provide decoration, identification and/or information, for example, on the contents of the container. The use of polymer containers, for example bottles made of thermoplastic polymers, has been increasing. One of the most popular polymer used in bottles is polyethylene terephthalate (PET). The containers, such as bottles in the beverage industry, are generally reused or recycled and thus there is a need for labels which are easily removed from the surface of the container during washing processes including for example exposure to hot dilute caustic soda.

Environmental and health restrictions on emission of organic solvents from industrial processes have driven development of water-borne pressure sensitive adhesives, which are based on colloidally stable aqueous dispersions of polymer particles. However, water-based pressure sensitive adhesives often suffer limitations in adhesive strength and in their ability to bond to non-polar substrates. Moreover, water-based adhesives in wash-off processes typically suffer from poor wet anchorage, which causes the adhesive to disintegrate into the washing liquid, thus contaminating the washing liquid and eventually the polymer material to be recycled. Therefore, solutions overcoming these drawbacks are desired.

### SUMMARY

This specification provides a wash-off label comprising a water-borne pressure sensitive adhesive. The wash-off label disclosed herein is detachable from the surface it has been attached to by exposing the labels to alkaline washing conditions. When detached, the adhesive remains with the face material. Thus the wash-off label disclosed herein is entirely detachable from the labelled surface. As the adhesive remains attached to the face material of the label, the adhesive does not pollute the washing solution or contaminate the recyclable material. This enables reuse of the washing solution, thus providing more sustainable and cost-efficient process. Further, quality of the recyclable material (e.g. PET flakes) is improved.

A wash-off label comprising a face and a pressure sensitive adhesive adjoined to the face is provided. The face comprises corona discharged filmic material, an adhesive receiving surface of the face being corona discharge treated, and the pressure sensitive adhesive has a composition including
at least one acrylic polymer comprising acrylic monomer(s) and/or non-acrylic comonomer(s) having a carbonyl group capable of undergoing a crosslinking reaction, amount of the acrylic monomer(s) and/or non-acrylic comonomer(s) having a carbonyl group capable of undergoing a crosslinking reaction being from 0.1 to 5 wt. % of monomer composition, and
a crosslinking agent with dihydrazide functionality, amount of the crosslinking agent being from 20 to 150% with respect to the amount of the carbonyl groups capable of undergoing a crosslinking reaction.
   The wash-off label is detachable from a surface when exposed to an alkaline washing solution at a temperature of 85 degrees C., the detachability being such that the pressure sensitive adhesive remains attached to the face.

A labelled item comprising an item and a wash-off label disclosed herein is provided. The wash-off label is attached to a surface of the item via the pressure sensitive adhesive of the wash-off label. Further, use of the wash-off label disclosed herein for labelling of a beverage bottle is provided.

A label laminate web comprising a face, a pressure sensitive adhesive and a release liner is provided. The face is adjoined to the release liner via the pressure sensitive adhesive. The face comprises corona discharged filmic material, an adhesive receiving surface of the face being corona discharge treated, and the pressure sensitive adhesive has a composition including
at least one acrylic polymer comprising acrylic monomer(s) and/or non-acrylic comonomer(s) having a carbonyl group capable of undergoing a crosslinking reaction, amount of the acrylic monomer(s) and/or non-acrylic comonomer(s) having a carbonyl group capable of undergoing a crosslinking reaction being from 0.1 to 5 wt. % of monomer composition, and
a crosslinking agent with dihydrazide functionality, amount of the crosslinking agent being from 20 to 150% with respect to the amount of the carbonyl groups capable of undergoing crosslinking reaction.

A method of manufacturing a wash-off label is provided. The method comprises
arranging a face or a release liner as a substrate,
coating the substrate with pressure sensitive adhesive, prior to labelling, cutting the face so as to form wash-off labels comprising the face and the pressure sensitive adhesive adjoined to the face, wherein the face comprises corona discharged filmic material, an adhesive receiving surface of the face being corona discharge treated, and the pressure sensitive adhesive has a composition including
at least one acrylic polymer comprising acrylic monomer(s) and/or non-acrylic comonomer(s) having a carbonyl group capable of undergoing a crosslinking reaction, amount of the acrylic monomer(s) and/or non-acrylic comonomer(s) having a carbonyl group capable of undergoing a crosslinking reaction being from 0.1 to 5 wt. % of monomer composition, and
a crosslinking agent with dihydrazide functionality, amount of the crosslinking agent being from 20 to 150% with respect to the amount of the carbonyl groups capable of undergoing crosslinking reaction.
   The wash-off label is detachable from a surface when exposed to an alkaline washing solution at 80-90 degrees C., the detachability being such that the pressure sensitive adhesive remains attached to the face.

A pressure sensitive adhesive composition for a wash-off label is provided. The wash-off label is detachable from a surface when exposed to an alkaline washing solution at a temperature of 85 degrees C., the detachability being such that the pressure sensitive adhesive remains attached to a face. The pressure sensitive adhesive composition includes
at least one acrylic polymer comprising acrylic monomer(s) and/or non-acrylic comonomer(s) having a carbonyl group capable of undergoing a crosslinking reaction, amount of the acrylic monomer(s) and/or non-acrylic comonomer(s) having a carbonyl group capable of undergoing a crosslinking reaction being from 0.1 to 5 wt. % of monomer composition, and
a crosslinking agent with dihydrazide functionality, amount of the crosslinking agent being from 20 to 150% with respect to the amount of the carbonyl groups capable of undergoing crosslinking reaction.

### BRIEF DESCRIPTION OF THE DRAWINGS

FIG. 1 illustrates, by way of an example, a wash-off label according to an embodiment,

FIG. 2 illustrates, by way of an example, a labelled item according to an embodiment,

FIG. 3 illustrates, by way of an example, a label laminate web according to an embodiment,

FIG. 4a illustrates, by way of an example, a photograph of washing liquids after wash-off tests, and

FIG. 4b illustrates, by way of an example, a photograph of a wash-off test.

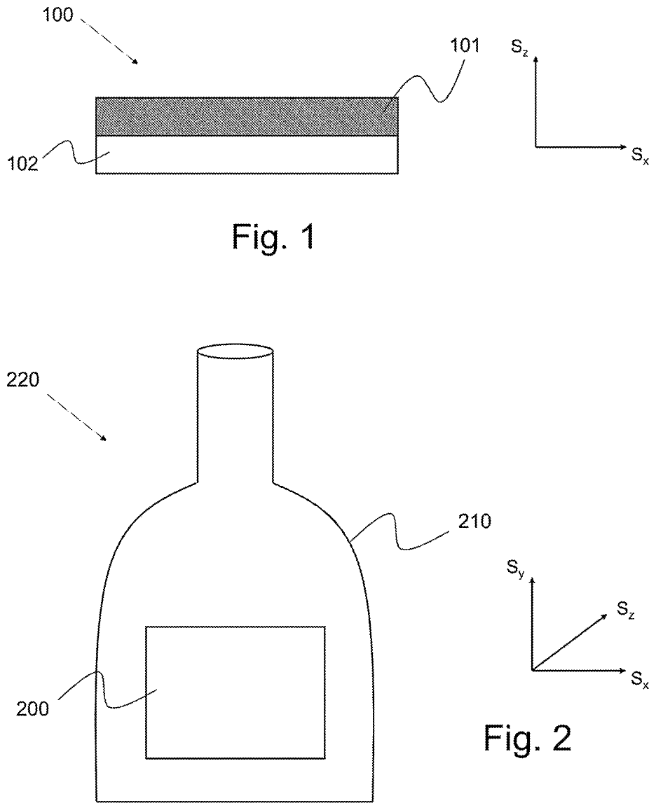

The FIGS. 1-3 are schematic. The figures are not in any particular scale.

### DETAILED DESCRIPTION

The solution is described in the following in more detail with reference to some embodiments, which shall not be regarded as limiting.

In this description and claims, the percentage values relating to an amount of a material are percentages by weight (wt. %) unless otherwise indicated. Unit of thickness expressed as microns corresponds to μm. Unit of temperature expressed as degrees C. corresponds to ° C. The following reference numbers and denotations are used in this application:

| Sₓ, S_{y}, S_{z} | 3D coordinates |
|---|---|
| 100, 200 | wash-off label |
| 101, 301 | face |
| 102, 302 | pressure sensitive adhesive |
| 210 | item |
| 220 | labelled item |
| 330 | label laminate web |
| 340 | release liner |

A label is a piece of material to be applied onto articles or items of different shapes and materials. An article or an item may be a package. A label comprises at least a face material also referred to as a face stock or a face. A typical way to adhere the label onto an article or an item is by use of adhesive. The label comprising an adhesive layer is referred to as an adhesive label. The adhesive may comprise pressure sensitive adhesive (PSA). A label comprising pressure sensitive adhesive may be referred to as a pressure sensitive adhesive label. Pressure sensitive adhesive labels may also be referred to as self-adhesive labels.

The labels comprising PSA can be adhered to most surfaces through an adhesive layer without the use of a secondary agent, such as a solvent, or heat to strengthen the bond. In that case the adhesive is pressure sensitive as such. Alternatively, the adhesive may be activatable in order to be pressure sensitive. The PSA forms a bond when pressure is applied onto the label at ambient temperature (e.g. between 15 and 35 degrees C.) or for cold applications even under freezing temperatures below 0 degrees C. or for hot applications in temperatures above 35 degrees C., adhering the label to the item/article to be labelled. Examples of pressure sensitive adhesives include water-based (water-borne) PSAs, solvent based PSAs and hot-melt PSAs. A label may further comprise other adhesive(s).

Term “face” refers to a top substrate of the label, also called as a face stock, a face material or in case of plastic, i.e. filmic, material a face film. The face may have a monolayer structure or a multilayer structure comprising at least two layers. In case of a plastic material the multilayer filmic structure may be co-extruded or it may comprise several layers laminated together. The face is the layer that is adhered to the surface of an article/item during labelling through an adhesive layer. The face comprises an adhesive side and a print side. A combination comprising a face and adhesive may be referred to as an adhesive label. The face may comprise e.g. print in order to provide information and/or visual effect. Printable face is suitable for printing by any known printing methods, such as with gravure, flexographic process, offset, screen or letter-press. The print may exist on a top surface, reverse side or both top and reverse side of the face. Further, the label may contain additional layers, for example top coatings or overlaminates to protect the top surface and/or print of the label against rubbing or other external stress. Coating or additional layers, such as a primer, may enable enhancing compatibility of adjacent layers or parts of the label, for example adhesion between the layers. A label comprising a face, a print layer and an adhesive may be referred to as a printed label.

Term “release liner” refers to a structure comprising a substrate and a release layer on a surface of the substrate contacting the adhesive in a label laminate. The substrate may also be called a backing material. The release liner may comprise a release agent. The release agent is a chemical having low surface tension. The release agent may be used in order to prevent other materials from bonding to it and to provide a release effect. Release liners of the label laminates may serve one or more useful functions: they may be used as a carrier sheet onto which the adhesive is coated; they may protect the adhesive layer during storage and transportation; they may provide a support for labels during die-cutting and printing, and ultimately they may provide the release substrate carrying the labels for dispensing onto the items/articles to be labelled.

Term “label laminate”, also referred to as an adhesive label laminate refers to a product comprising a face, adhesive and a release liner. In the label laminate the face is laminated together with the release liner having the adhesive in between. The label laminate may be a continuous structure from which the individual labels may be die-cut. The release liner of the label laminate is typically removed prior to labelling i.e. attaching the label onto the surface of an item to be labelled.

Individual labels may be cut from the label laminate structure. After cutting, the labels may remain to be attached to a common release liner (the release liner remains uncut). Thus, a plurality of labels may remain to be attached to a common continuous release liner. This may be called a converted label web. Alternatively, the labels may be completely separate (i.e. also the release liner may be cut). A label, including a face and adhesive, may be separated from the release liner e.g. by pulling the release liner in the direction −Sz with respect to the label. Thus, a surface of the adhesive layer is exposed so that said surface can be attached to an article/item.

The label may also be a so-called linerless label. The linerless label comprises a mono- or multilayer face and an adhesive on the face. Alternatively the label may be a so-called shrink label, where the heat shrinkable polymeric face material(s) are seamed and rolled on or sleeved around labelled articles and shrunk around the items. Shrinkable labels may comprise additionally some pressure sensitive adhesive(s) or those may be produced completely without pressure sensitive adhesive, or even without seaming adhesive.

Term “web” refers to a continuous sheet of material. The web is generally processed by moving over rollers. Between processing stages, webs may be stored and transported as rolls.

Term “laminate web” refers to a structure comprising two or more continuous sheets of material attached together into a web format. Typically, the laminate web comprises a face material attached (laminated) onto a release liner via a pressure sensitive adhesive.

Labels may be used in wide variety of labelling applications and end-use areas, such as labelling of food, home and personal care products, industrial products, pharmaceutical and health care products, beverage and wine bottles, other consumables etc. Labels enable providing information, like product specification, on the labelled product(s). Information, e.g. print of a label, may comprise human-readable information, like image(s), logo(s), text, and/or machine-readable information, like bar code(s), QR (Quick Response) code(s). The surface of the labelled article/item may be for example plastics, glass, metal, or paper based. The labelled article/item may be for example a container, such as a bottle, jar, canister, can, tin or the like. The label may also be applied to semi-rigid or flexible packages used for e.g. packaging of food.

This specification aims to provide a wash-off label. A wash-off label, also referred to as a washable label, refers to a label removable (detachable) from a surface of an item attached to during subsequent washing process. A wash-off label comprises an adhesive sensitive to washing conditions.

Adhesive sensitive to washing conditions refers to an adhesive having decreased adhesion at washing conditions. The adhesive sensitive to washing conditions is able to reduce its adhesion (tackiness) in washing conditions. The washing conditions generally comprise alkaline conditions (washing solution) and/or increased temperature. Within context of this specification, the adhesion of the adhesive to the labelled item decreases more than the adhesion to the label face so that the adhesive remains attached to the face. The increased temperature may be at least 50 degrees C., for example 65, 70, 75, 80, 85 or 90 degrees C. The alkaline conditions refer to an aqueous solution containing an alkaline agent, such as NaOH, KOH or combination thereof. Probably the most common alkaline agent is sodium hydroxide (NaOH), which is also called caustic soda. The washing conditions (i.e. the alkaline conditions) generally contain about 0.5-10% or 1-4% (by weight) of the alkaline agent(s). For example, the washing solution contains about 2% (by weight) alkaline agent(s).

In typical washing and separation processes relating to the recycling of plastic items, such as bottles, the plastic items are exposed to a washing solution and the items in the washing solution are agitated at elevated temperature. The plastic items are typically crushed into flakes before exposing them to the washing solution. After that, the items/flakes are rinsed so as to remove the washing solution. Then, after settling of the material the system comprises floating material on a surface of the rinsing liquid as well as material that has a density higher than the one of the rinsing liquid, thus sinking to the bottom. Thus, the floated material may be separated from the sank material. The sank material typically contains the plastic items or flakes thereof.

The wash-off labels disclosed herein are detachable from the surface they have been attached to by exposing the labels to washing conditions discussed above. When detached, the adhesive remains with the face material. Thus the wash-off labels disclosed herein are entirely detachable from the labelled surface. As the adhesive remains attached to the face material of the label, the adhesive does not pollute the washing solution or contaminate the recyclable material. This enables reuse of the washing solution, thus providing more sustainable and cost-efficient process. Further, quality of the recyclable material (e.g. PET flakes) is improved.

### Adhesive Composition

Adhesive composition disclosed herein is water-based, i.e. aqueous or water-borne, polymer emulsion (also called aqueous polymer dispersion). The adhesive composition may also be called a latex. Latex is a stable dispersion (emulsion) of polymer particles in water. Latex solidifies by coalescence of the polymer particles as the water evaporates.

The latex disclosed herein has a high solid content, typically higher than 60%. The adhesive composition disclosed herein may have a solid content of from 60% to 70%, for example 63-65%. Solid content may be measured according to standard DIN EN ISO 3251. Such water based dispersions with high polymer content are of particular interest since relatively low portion of water has to be removed during drying which translates into lower energy consumption. Development and use of high solid dispersion has positive impact on environment since less material has to be transported and as a result carbon footprint is reduced. Use of a high solid content adhesive in label manufacturing enables a more energy efficient, and thus more sustainable overall process. Despite of the high solids content, the Brookfield viscosity of the adhesive disclosed herein is as low as below 1000 cP, when measured at 100 rpm with spindle RV-3 or HA-3 or HB-3.

There are several methods which allow production of high solid latex at manageable viscosity based on precise control of particle size distribution. This is achieved either by designing broad particle size distribution or by generating particular number of particle populations.

The high solid content adhesive composition may be achieved by controlling the particle size distribution in the polymerization process. As an example, the polymerization process may provide a polymer dispersion having a bimodal or multimodal particle size distribution. An exemplary polymerization process may provide a bimodal polymer dispersion, which comprises 60-80% of total volume particles having a particle size of 500-700 nm and 20-40% of total volume particles having a particle size of 80-200 nm. As an example, the polymer dispersion disclosed herein may be polymerized by using so-called external seed technology. The polymer dispersion disclosed herein may be produced by first providing small particles as seeds and allowing them to grow, thereafter providing more seed particles, and allowing all of the particles to grow together in order to form a polymer dispersion wherein the particles are very well packed in.

Water-based adhesives when compared to solvent-based ones provide better sustainability with less fossil-based raw materials and less volatiles involved both during the manufacturing and during end use.

The adhesive composition comprises at least one acrylic polymer. The at least one acrylic polymer comprises a reactive group capable of undergoing a crosslinking reaction. The adhesive composition further comprises a crosslinking agent.

The at least one acrylic polymer is a polymerization product of acrylic monomer(s), and optionally non-acrylic comonomer(s). Thus, the at least one acrylic polymer or the adhesive composition may be composed of acrylic monomer(s) solely, or alternatively of acrylic monomer(s) and non-acrylic comonomer(s).

Examples of acrylic monomers include esters of prop-2-enoic acid (acrylic acid, AA) and 2-methylprop-2-enoic acid with methanol (methyl methacrylate, MMA), ethanol, propan-1-ol or propan-2-ol, esters of prop-2-enoic acid or 2-methylprop-2-enoic acid with butan-1-ol, 2-methylpropan-1-ol, butan-2-ol, 2-methylpropan-2-ol, pentan-1-ol, 3-methylbutan-1-ol, 2,2-dimethylpropan-1-ol, hexano-1-ol, heptan-1-ol, octan-1-ol, 2-ethylhexan-1-ol, 6-methylheptan-1-ol, nonan-1-ol, 7-methyloctan-1-ol, dodecan-1-ol, 8-methylnonan-1-ol, undecane-1-ol or dodecan-1-ol, alkyl (meth)acrylate, aliphatic/alicyclic esters of prop-2-enoic acid or 2-methylprop-2-enoic acid with trideca-1-ol, tetradecan-1-ol, pentadecan-1-ol, hexaden-1-ol, octadecan-1-ol, cyclohexanol, (1S,2S,4S)-1,7,7-trimethylbicyclo[2.2.1]heptan-2-ol and the other isomers thereof as well as diesters of prop-2-enoic acid and 2-methylprop-2-enoic acid with diols such as ethane-1,2-diol, propane-1,2-diol, propane-1,3-diol, butane-1,3-diol, butane-1,4-diol, and also 1,2-bis(ethenyl)benzene, ethenyl 2-methylprop-2-enoate, prop-2-enyl 2-methylprop-2-enoate, prop-2-enyl prop-2-enoate, bis(prop-2-enyl) (Z)-but-2-enedioate, bis(prop-2-enyl) (E)-but-2-enedioate, N-[(prop-2-enoylamino)methyl]prop-2-enamide.

Vinyl monomers such as styrene, prop-1-en-2-ylbenzene (alpha-methylstyrene), or vinyltoluenes, vinyl esters of neoalkanoic acids, and particularly ethenyl acetate (vinyl acetate, Vac) may be used as non-acrylic comonomers. VAc undergoes hydrolytic degradation and may be obtained from renewable resources.

In case styrene is used as non-acrylic comonomer its amount is preferably less than 5 wt. % of the monomer composition. Styrene is 100% petroleum-based, and thus it may be desirable to limit or even avoid its use. Thus, in an embodiment, the monomer composition is styrene-free. The styrene-free monomer composition may consist of monomers from renewable resources. This has the effect of providing an adhesive with reduced carbon footprint.

Other useful monomers comprising an amide group may be selected for example from prop-2-enamide, 2-methylprop-2-enamide, 1-ethenylpyrrolidin-2-one, N,N-dimethylprop-2-enamide, N,N-2-trimethylprop-2-enamide. Suitable monomers improving stability of particles may include ethenesulfonic acid, 2-methyl-2-(prop-2-enoylamino) propane-1-sulfonic acid, 4-ethenylbenzenesulfonic acid and their water-soluble salts.

The reactive group capable of undergoing a crosslinking reaction of the at least one acrylic polymer is a carbonyl group. The carbonyl group may originate from a ketone or an aldehyde. Thus, the at least one acrylic polymer is a polymerization product of acrylic monomer(s), and optionally non-acrylic comonomer(s), wherein at least one acrylic monomer or non-acrylic comonomer comprises a reactive group capable of undergoing a crosslinking reaction, which reactive group is a carbonyl originating from a ketone or an aldehyde. The amount of acrylic monomer(s) and/or non-acrylic comonomer(s) comprising a carbonyl as a reactive group capable of undergoing a crosslinking reaction is from 0.1 wt. % to 5 wt. %, for example 1-3 wt. %, of the monomer composition.

Carboxyl functionality may be introduced into polymer chain by copolymerisation with unsaturated acids such as prop-2-enoic acid and 2-methylprop-2-enoic acid, 2-methylidenebutanedioic acid, (2Z)-but-2-enedioic acid, (2Z)-but-2-enedioic acid, (2E)-but-2-enoic acid, methacrylic acid, 2-carboxyethyl acrylate. Providing carboxyl functionality may improve latex stability and enable further crosslinking.

Examples of acrylic monomers comprising a ketone group as the reactive group capable of undergoing a crosslinking reaction include N-(2-methyl-4-oxopentan-2-yl) prop-2-enamide (diacetone acrylamide, DAAM) and 2-(2-methylprop-2-enoyloxy)ethyl 3-oxobutanoate (acetoacetoxy ethyl methacrylate, AAEM).

According to an embodiment, the monomer composition for the pressure sensitive adhesive disclosed herein consists of butyl acrylate, acrylic acid, 2-ethylhexyl acrylate (2-EHA), methyl methacrylic acid and diacetone acrylamide.

The crosslinking agent, i.e. a crosslinker or a crosslinking reagent, is a chemical entity that is capable of linking one polymer chain to another. Thus, within context of this specification, the crosslinking agent is capable of linking one acrylic polymer chain to another. In crosslinking a chemical reaction between the polymer chain(s) and the crosslinking agent takes place and a crosslink is formed.

Crosslinking agents capable of reacting with ketone or aldehyde groups include for example crosslinkers with dihydrazide functionality or diamino acid such as lysine. Dihydrazides are formed by a reaction of an organic acid with hydrazine. Hexanedihydrazide (adipic dihydrazide, ADH) is an example of a suitable crosslinking agent with dihydrazide functionality. Other useful crosslinkers may be selected from group of aliphatic diamines or polyether amines. Crosslinkers containing amine functionality are also capable of reacting with epoxy groups introduced into polymer by copolymerisation with oxiran-2-ylmethyl 2-methylprop-2-enoate (glycidyl methacrylate, GMA). An example of a crosslinking agent capable of reacting with hydroxyl functionality is water-dispersible polyisocyanate. According to an embodiment, the crosslinking agent is adipic dihydrazide.

The crosslinking agent of the adhesive composition disclosed herein is capable of reacting with the reactive group of the at least one acrylic polymer, i.e. the carbonyl group, thus forming a crosslink.

By adjusting the amount of the crosslinking agent, the properties such as the adhesion-cohesion balance of the adhesive composition may be tuned. Thus, multiple application requirements can be met by adjusting the amount of the crosslinking agent and thus the amount of the crosslinking taking place within the adhesive composition. In principle, the lesser the amount of crosslinking agent used, the higher the adhesion of the adhesive composition. The higher the amount of the crosslinking agent used, the higher the cohesion of the adhesive composition.

By using less crosslinking agent, such as 0-20% of the amount of the reactive groups capable of undergoing a crosslinking reaction, permanent adhesion properties may be obtained. When the amount of the crosslinking agent is adjusted to be for example 20-70% of the amount of the reactive groups capable of undergoing a crosslinking reaction, an adhesive with semi-permanent or semi-removable adhesion properties may be obtained. In order to provide a removable or even ultra-removable adhesive composition, the amount of the crosslinking agent may be adjusted to be for example 70-100% of the amount of the reactive groups capable of undergoing a crosslinking reaction. It is also possible to adjust the amount of the crosslinking agent to be more than 100%, for example 100-150% of the amount of the reactive groups capable of undergoing a crosslinking reaction. In that case the adhesive composition will contain polymer chains grafted with the crosslinking agent. Thus, the polymer chains contain branches with crosslinking functionality.

Within context of this specification, the amount of the crosslinking agent is from 20 to 150% with respect to the amount of the carbonyl groups capable of undergoing crosslinking reaction.

In an embodiment, the amount of the crosslinking agent is stoichiometric. Pressure sensitive adhesive that comprises stoichiometric amount of crosslinking agent is 100% crosslinked. Stoichiometric amount of crosslinking agent means that the adhesive contains a crosslinking agent available for every reactive group capable of undergoing a crosslinking reaction. In 100% crosslinked pressure sensitive adhesive all of the reactive groups capable of undergoing a crosslinking reaction have undergone the crosslinking reaction, i.e. have undergone a reaction with the crosslinking agent.

For providing the pressure sensitive adhesive composition, the aqueous polymer emulsion may be formulated by adding at least one of a neutralizing agent, a wetting agent, a biocide, a defoamer, a rheology modifier.

The pressure sensitive adhesive composition disclosed herein is tackifier-free, i.e. it does not contain a tackifier or a tackifying resin for increasing the tack, i.e. the stickiness of the adhesive surface. Tackifiers may be responsible for causing yellowing, and thus their use with at least clear face films is not preferred. Further, tackifiers typically are not 100% compatible with the acrylic polymers, thus causing a non-homogeneous adhesive film to form. The non-homogeneous adhesive film typically does not show good water whitening resistance. Furthermore, the tackifier components typically contain hydrophilic emulsifiers, which also is not beneficial for the water whitening resistance.

The adhesive composition disclosed herein exhibits good water whitening resistance. Water whitening may also be called blushing. Water whitening refers to loss of optical transparency due to the absorption of water causing the adhesive to become translucent or opaque, when exposed to moisture or water, for example when being immersed in water. The pressure sensitive adhesive composition disclosed herein has water whitening resistance being able to maintain the clarity also when exposed to moist or humid conditions. Good water whitening resistance results from well controlled particle size distribution leading to good packing in adhesive film as well as from tight crosslinking which provides high cohesion. Water whitening resistance of the adhesive layer is beneficial in achieving transparent ‘no label’ look appearance of the label and the label being suitable, for example, in applications where the object(s) beneath the label should be visible through the label. Moreover, the adhesive composition can be used at wide temperature range. Wide temperature range may cover a range from minus degrees C. to even over 50 degrees C., for example to 80-100 degrees C. Due to the crosslinking mechanism the adhesive composition disclosed herein exhibits unlimited shelf-life.

The adhesion properties include shear resistance, which may be used as an indicator of the adhesive's cohesion, as well as peel adhesion and tack, which are indicators of the adhesive's adhesion.

Shear resistance refers to a measure of an adhesive's vertical holding power, i.e. internal cohesive strength (cohesion) of the adhesive. It is generally measured by arranging a specific surface area of adhesive to a substrate, attaching a known weight to the adhesive and the substrate, and then measuring the time the adhesive would hold the weight. Shear resistance may be measured according to FINAT Test Method No. 8 (FTM 8). A low-shear adhesive (soft) has more of a tendency to flow resulting in higher initial tack. However, low-shear adhesive may have a higher chance of the adhesive being split under stress. A high-shear adhesive (firm) is less likely to split under stress due to its higher internal cohesive strength. The high-shear adhesive may have reduced tendency to flow and thus may have lower initial tack. The pressure sensitive adhesive disclosed herein shows high shear resistance. The shear resistance of the adhesive disclosed herein may be higher than 10 000 min, when measured according to FTM 8.

Peel adhesion refers to a measure of the adhesive's ability to wet out a surface of a substrate and subsequently adhere to the substrate. Peel adhesion thus may quantify the permanence of the adhesion or peel ability of the adhesive. Peel adhesion is defined as the force required to remove adhesive coated material from a standard test plate after a certain dwell time at an angle of 90 degrees or 180 degrees and specified speed. Peel adhesion thus refers to final adhesion. Peel adhesion may be measured according to FINAT Test Method No. 1 or 2 (FTM 1, FTM 2).

According to an embodiment, the adhesive has a peel adhesion on PET surface in a range of from 0.1 to 10 N/25 mm, when measured according to FTM 1 or FTM 2. For example, the adhesive may have a peel adhesion on PET surface in a range of from 2 to 7 N/25 mm, such as 3.8 N/25 mm.

Tack refers to an adhesive's holding power (adhesion) upon contact with a substrate. An adhesive with high initial tack will grab the substrate quickly. An adhesive with low initial tack will exhibit a low level of adhesion when applied. Tack can be measured by loop tack measurement according to FINAT Test Method No. 9 (FTM 9). The loop tack value of the adhesive is expressed as the force required to separate, at specified speed, a loop of material brought into contact with a specified area of a standard surface. The pressure sensitive adhesive disclosed herein shows tack on glass surface in a range of from 0.1 to 10 N, when measured according to FTM 9. For example, the adhesive may have tack on glass in a range of from 1.5 to 5 N, such as 3.4 N.

The adhesive composition disclosed herein is applicable to indirect food contact. The adhesive composition disclosed herein emits low amount of volatile organic compounds (VOCs). All components of the adhesive are in compliance with EU regulations (EU October 2011) for indirect food contact. Moreover, tight crosslinking is responsible for reducing the amount of material extractable from the adhesive composition.

### Wash-Off Label

FIG. 1 illustrates a side view in the Sₓ,S_{z}-plane of a wash-off label 100 according to this disclosure. The wash-off label 100 comprises a face 101 and a pressure sensitive adhesive 102 adjoined to the face. The face 101 comprises or consists of plastic, i.e. filmic material. The face comprises or consists of corona discharged filmic material. The face 101 may comprise or consist of polypropylene (PP), polyethylene (PE) or polyethylene terephthalate (PET).

According to an embodiment, the face 101 of the wash-off label 100 disclosed herein consists of plastic, i.e. filmic material. The face 101, i.e. the filmic material is corona discharged.

A surface of the face that is arranged to be next to the adhesive, i.e. the adhesive receiving surface is corona treated, i.e. exposed to corona discharge treatment in order to provide the adhesive receiving surface of the face with improved properties for adhesive anchorage. The corona discharge treated adhesive receiving surface of the face is able to chemically interact with the crosslinking agent comprised by the pressure sensitive adhesive composition. Thus, crosslinks between the polymers of the adhesive and the polymers of the face are formed. As a result, the adhesive anchorage is improved.

The pressure sensitive adhesive 102 comprises or consists of water-based pressure sensitive adhesive composition as discussed above. The pressure sensitive adhesive composition includes a crosslinking agent and at least one acrylic polymer which has a carbonyl group as a reactive group capable of undergoing a crosslinking reaction with said crosslinking agent. The pressure sensitive adhesive composition comprises the crosslinking agent in an amount of from 20 to 150% with respect to the amount of the carbonyl groups capable of undergoing a crosslinking reaction.

The wash-off label is detachable, i.e. removable from a surface when exposed to a washing process. In the washing process the adhesion of the adhesive to the labelled item decreases more than the adhesion to the label face so that the adhesive remains attached to the face.

The washing process comprises elevated temperature of at least 50 degrees C., for example 65, 70, 75, 80, 85 or 90 degrees C. The washing process comprises alkaline conditions. The alkaline conditions refer to an aqueous washing solution containing an alkaline agent, such as NaOH, KOH or combination thereof. The aqueous washing solution preferably comprises at least 95% (by weight) water. Preferably the alkaline agent is sodium hydroxide (NaOH), which is also called caustic soda. The washing conditions (i.e. the alkaline conditions) generally contain about 0.5-10%, 0.5-5% or 1-4% (by weight) of the alkaline agent(s). For example, the washing solution contains about 2% (by weight) alkaline agent(s). The washing process preferably comprises agitating the mixture comprising the items to be washed as well as the washing solution. Agitation may be performed for example at a rate of 500 rpm. Duration of the washing process may be for example 15 minutes.

As the adhesive remains attached to the face material of the label, the adhesive does not pollute the washing solution or contaminate the recyclable material. This enables reuse of the washing solution, thus providing more sustainable and cost-efficient process. Further, quality of the recyclable material (e.g. PET flakes) is improved.

FIG. 4a shows a photograph of washing liquids after wash-off tests. The three samples from the left are representatives of failed wash-off tests. The wet anchorage of the adhesive of the labels studied has not been good enough and because of the high mechanical forces the wash-off labels have been exposed to during the washing process, the adhesive has disintegrated and is seen as particles in the washing liquid received from failed wash-off tests. This is not acceptable, as the adhesive particles pollute the washing liquid and contaminate the washed items or flakes thereof. Thus the washing liquid cannot be reused, at least not without purification. Contamination of the items or flakes thereof deteriorates the recyclability of the material and/or the quality of the recycled material. The right-most sample, for one, is a representative of washing liquid received from approved wash-off test. In said sample the aqueous washing liquid is clear, having no visible adhesive particles therein.

FIG. 4b shows a photograph of an approved wash-off test. The plastic (PET) items have been crushed into flakes before exposing them to the washing solution. The FIG. 4b shows that after settling of the material the system comprises floating and sinking fractions in a clear washing liquid. The washed wash-off labels, i.e. the face and the adhesive still adhered to the face form the floating fraction, whereas the PET items form the sinking fraction. The aqueous washing liquid is clear, having no visible adhesive particles therein.

The wash-off label disclosed herein may be used for providing a labelled item, as is illustrated in FIG. 2. The labelled item 220 comprises an item 210 and a wash-off label 200 disclosed above. The wash-off label 200 is attached to a surface of the item via the pressure sensitive adhesive of the label. The item may be for example a beverage bottle. The beverage bottle may be a PET bottle.

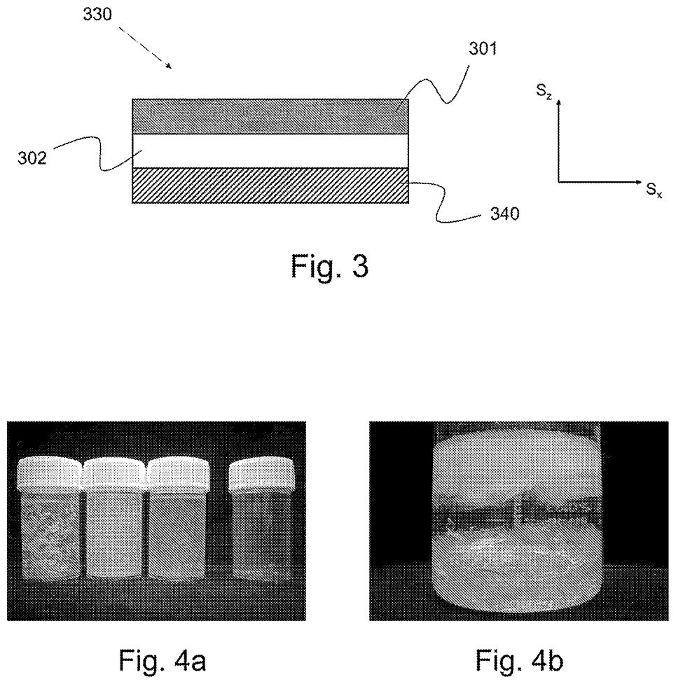

A label laminate web 330 as illustrated in FIG. 3 may be provided for providing the wash-off labels as disclosed herein. The label laminate web comprises a face 301, a pressure sensitive adhesive 302 and a release liner 340. The face 301 is adjoined to the release liner 340 via the pressure sensitive adhesive 302. The face 301 comprises or consists of corona discharged filmic material. Details of the pressure sensitive adhesive are discussed above.

The label laminate web may be die-cut in order to form a converted label web. The converted label web comprises the release liner with the wash-off labels disclosed herein attached onto it.

A wash-off label may be manufactured by arranging a face or a release liner as a substrate and coating the substrate with pressure sensitive adhesive disclosed herein. Prior to labelling, the face is cut so as to form wash-off labels disclosed herein. For linerless labels, the substrate is a face. For linerless labels the substrate, i.e. the face has been exposed to corona discharge treatment.

In order to produce a wash-off label from a label laminate, the substrate may be a face comprising or consisting of corona discharged filmic material, or a release liner. The manufacturing method comprises laminating the release liner together with the face in such a way that the pressure sensitive adhesive is arranged in between the face and the release liner so as to form a label laminate web. The method comprises die-cutting the label laminate web so as to form a converted label web. The converted label web comprises the release liner with the wash-off labels attached onto it.

### Examples

An adhesive for a wash-off label was prepared as described below.

### Preparation of Seed:

2562.5 g of 4.5% water solution of Calfax DB-45 was introduced into jacketed reactor equipped with anchor type agitator and reflux condenser and heated to 82 degrees C. Once reaction temperature was reached, first portion of 4% ammonium persulfate solution was fed into reactor at 12.7 g/min. Five minutes later, 1158.6 g of BA and AA at 99:1 ratio was fed into reactor simultaneously with remaining solution of initiator with a feeding rate of 0.085 g/min over 150 minutes. 1 h after completion of reaction, ammonia solution was used to adjust pH to 7. Particle size measured with Malvern Zetasizer DLS device was 45 nm.

### Preparation of Polymer Dispersion:

Monomer premix was prepared by homogenising in glass vessel 381.32 g of 2-EHA, 221.10 g of BA, 25.63 g of MMA, 6.41 g of DAAM, 6.41 g of AA and 0.45 g of n-DDM in 103.13 g solution of 22.40 g of Rhodafac RS 601 A25 and 7.73 g of Rhodapex LA300/SB in water. Next, glass jacketed reactor equipped with reflux condenser and anchor type agitator was filled with 186.28 g 0.3% solution of sodium bicarbonate, 0.6 g of seed and heated to 81 degrees C. At the reaction temperature ⅓ of 4.5% ammonium persulfate solution was introduced into reactor and 5 minutes later remaining part of initiator were fed at feeding rates shown in Table 1.

TABLE 1

| | Premix | Initiator | Time |
|---|---|---|---|
| | [g/min] | [g/min] | [min] |
| Stage 1 | 1.50 | 0.12 | 30 |
| Stage 2 | 2.27 | 0.12 | 30 |
| Stage 3 | 3.01 | 0.12 | 210 |

After 155 minutes from the beginning of feeding, second portion of seed (3.41 g) was fed within 5 min into the reactor.

After all feeds were completed batch was held for 1 h at reaction temperature. In the next phase the temperature was decreased to 65 degrees C. and redox treatment took place. 0.61 g of 70% solution of t-butyl hydroperoxide diluted in 3.16 g of water was introduced to the reactor, followed by 0.61 g of Bruggolite FF6M dissolved in 3.16 g of water fed within 15 minutes. After additional 60 minutes batch that had been cooled down was discharged.

Final product had Brookfield viscosity of 322 cP measured at 100 rpm with spindle RV-3 or HA-3 or HB-3, solid content of 65% and pH of 3.0. Volume average particle size measured by laser diffraction technique was 431 nm.

Water-based acrylic PSA prepared as shown above was provided with a crosslinking agent with dihydrazide functionality (adipic dihydrazide). Effect of the amount of the crosslinking agent with respect to the carbonyl groups of the acrylic polymer capable of undergoing crosslinking reaction (crosslinkable groups) on the adhesion properties and washability were investigated.

Regarding washability, for the above disclosed exemplary acrylic polymer, use of stoichiometric amount of the crosslinking agent (100% of the crosslinkable groups crosslinked) gave the best result (100% washability at alkaline washing solution at 85 degrees C.). Tack on glass surface was 3.4 N, when measured according to FTM 9. Shear resistance was higher than 10 000 min, when measured according to FTM 8. Peel adhesion on PET surface was 3.8 N/25 mm, when measured according to FTM 1 or FTM 2.

1. A wash-off label (100, 200) comprising a face (101, 301) and a pressure sensitive adhesive (102, 302) adjoined to the face, wherein the face (101, 301) comprises corona discharged filmic material, an adhesive receiving surface of the face being corona discharge treated, and the pressure sensitive adhesive (102, 302) has a composition including
at least one acrylic polymer comprising acrylic monomer(s) and/or non-acrylic comonomer(s) having a carbonyl group capable of undergoing a crosslinking reaction, amount of the acrylic monomer(s) and/or non-acrylic comonomer(s) having a carbonyl group capable of undergoing a crosslinking reaction being from 0.1 to 5 wt. % of monomer composition, and
a crosslinking agent with dihydrazide functionality, amount of the crosslinking agent being from 20 to 150% with respect to the amount of the carbonyl groups capable of undergoing a crosslinking reaction, and wherein
the wash-off label (100, 200) is detachable from a surface when exposed to an alkaline washing solution at a temperature of 85 degrees C., the detachability being such that the pressure sensitive adhesive (102, 302) remains attached to the face (101, 301).

2. The wash-off label (100, 200) according to claim 1, wherein the reactive group capable of undergoing a crosslinking reaction is ketone or aldehyde.

3. The wash-off label (100, 200) according to claim 1, wherein the at least one acrylic polymer comprises N-(2-methyl-4-oxopentan-2-yl)prop-2-enamide or 2-(2-methylprop-2-enoyloxy)ethyl 3-oxobutanoate as an acrylic monomer.

4. The wash-off label (100, 200) according to claim 1, wherein the crosslinking agent is adipic dihydrazide.

5. The wash-off label (100, 200) according to claim 1, wherein the pressure sensitive adhesive composition has a solid content of higher than 60%.

6. The wash-off label (100, 200) according to claim 1, wherein the pressure sensitive adhesive composition has a viscosity below 1000 cP.

7. The wash-off label (100, 200) according to claim 1, wherein the pressure sensitive adhesive (102, 302) has a peel adhesion on PET surface in a range of from 0.1 to 10 N/25 mm, when measured according to FTM 1 or FTM 2.

8. The wash-off label (100, 200) according to claim 1, wherein the at least one acrylic polymer is styrene-free.

9. The wash-off label (100, 200) according to claim 1, wherein the amount of the crosslinking agent is stoichiometric with respect to the carbonyl groups capable of undergoing crosslinking reaction.

10. A labelled item (220) comprising an item (210) and a wash-off label (100, 200) according to claim 1, wherein the wash-off label (100, 200) is attached to a surface of the item via the pressure sensitive adhesive (102, 302) of the wash-off label.

11. The labelled item (220) according to claim 10, wherein the item (210) is a beverage bottle.

12. Use of the wash-off label (100, 200) according to claim 1 for labelling of a beverage bottle.

13. A label laminate web (330) comprising a face (101, 301), a pressure sensitive adhesive (102, 302) and a release liner (340), the face (101, 301) being adjoined to the release liner (340) via the pressure sensitive adhesive (102, 302), wherein the face (101, 301) comprises corona discharged filmic material, an adhesive receiving surface of the face being corona discharge treated, and the pressure sensitive adhesive (102, 302) has a composition including
at least one acrylic polymer comprising acrylic monomer(s) and/or non-acrylic comonomer(s) having a carbonyl group capable of undergoing a crosslinking reaction, amount of the acrylic monomer(s) and/or non-acrylic comonomer(s) having a carbonyl group capable of undergoing a crosslinking reaction being from 0.1 to 5 wt. % of monomer composition, and
a crosslinking agent with dihydrazide functionality, amount of the crosslinking agent being from 20 to 150% with respect to the amount of the carbonyl groups capable of undergoing crosslinking reaction.

14. A method of manufacturing a wash-off label (100, 200) according to claim 1, the method comprising
arranging a face (101, 301) or a release liner (340) as a substrate,
coating the substrate with pressure sensitive adhesive (102, 302), prior to labelling, cutting the face (101, 301) so as to form wash-off labels (100, 200) comprising the face (101, 301) and the pressure sensitive adhesive (102, 302) adjoined to the face (101, 301), wherein the face (101, 301) comprises corona discharged filmic material, an adhesive receiving surface of the face being corona discharge treated, and the pressure sensitive adhesive (102, 302) has a composition including
at least one acrylic polymer comprising acrylic monomer(s) and/or non-acrylic comonomer(s) having a carbonyl group capable of undergoing a crosslinking reaction, amount of the acrylic monomer(s) and/or non-acrylic comonomer(s) having a carbonyl group capable of undergoing a crosslinking reaction being from 0.1 to 5 wt. % of monomer composition, and
a crosslinking agent with dihydrazide functionality, amount of the crosslinking agent being from 20 to 150% with respect to the amount of the carbonyl groups capable of undergoing crosslinking reaction, and wherein
the wash-off label (100, 200) is detachable from a surface when exposed to an alkaline washing solution at 80-90 degrees C., the detachability being such that the pressure sensitive adhesive (102, 302) remains attached to the face (101, 301).

15. The method according to claim 14, comprising
laminating the release liner (340) together with the face (101, 301) in such a way that the pressure sensitive adhesive (102, 302) is arranged in between the face (101, 301) and the release liner (340) so as to form a label laminate web (330),
die-cutting the label laminate web (300) so as to form a converted label web, wherein the converted label web comprises the release liner (340) with the wash-off labels (100, 200) attached onto it.

16. A pressure sensitive adhesive composition for a wash-off label (100, 200), the wash-off label (100, 200) being detachable from a surface when exposed to an alkaline washing solution at a temperature of 85 degrees C., the detachability being such that the pressure sensitive adhesive (102, 302) remains attached to a face (101, 301),
wherein the pressure sensitive adhesive composition includes at least one acrylic polymer comprising acrylic monomer(s) and/or non-acrylic comonomer(s) having a carbonyl group capable of undergoing a crosslinking reaction, amount of the acrylic monomer(s) and/or non-acrylic comonomer(s) having a carbonyl group capable of undergoing a crosslinking reaction being from 0.1 to 5 wt. % of monomer composition, and
a crosslinking agent with dihydrazide functionality, amount of the crosslinking agent being from 20 to 150% with respect to the amount of the carbonyl groups capable of undergoing crosslinking reaction.
